(19) United States
(12) Patent Application Publication
(10) Pub. No.: US 2005/0122041 A1
(43) Pub. Date: Jun. 9, 2005

(54) Organic electroluminescent device

(75) Inventors: Hiroshi Tanabe, Yokohama-shi (JP); Kazunori Ueno, Ebina-shi (JP); Brendan Cowles, Cambridge, MA (US)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/967,355

(22) Filed: Oct. 19, 2004

(30) Foreign Application Priority Data
Oct. 22, 2003 (JP) 2003-361525

(51) Int. Cl. H01J 1/62

(52) U.S. Cl. 313/506

(57) ABSTRACT

There is provided an organic electroluminescent device including at least: a pair of electrodes including an anode and a cathode; one or more layers containing an organic compound interposed between the pair of electrodes; and a layer containing metallic boride provided between the cathode and one of the layers containing the organic compound. The organic electroluminescent device provides an electron injection material which has high chemical stability and is easy to control a composition of a film. The organic electroluminescent device has extremely high efficiency, a light output with high luminance, and extremely high durability.

### BACKGROUND OF THE INVENTION

1. Field of the Invention

The present invention relates to a charge injection type electroluminescent device, and more particularly to a charge injection type organic electroluminescent device using metallic boride.

2. Related Background Art

An organic electroluminescent device is a device where a thin film including a fluorescent organic compound or a phosphorescent organic compound is interposed between an anode and a cathode, an electron and a hole are injected from the respective electrodes to generate an exciton of the fluorescent compound or the phosphorescent compound, and light which is emitted when the exciton returns to a base state is utilized.

According to the study of Kodak company in 1987 (Appl. Phys. Lett. 51, 913 (1987)), there has been reported a electroluminescent with approximately 1000 cd/m² at an applied voltage of approximately 10 V in a device having a separated-function type two-layer configuration using ITO as an anode, a magnesium-silver alloy as a cathode, an aluminum quinolinol complex as an electron-transporting material and a luminescent material, and a triphenyl amine derivative as a hole-transporting material. The related patents include U.S. Pat. Nos. 4,539,507, U.S. Pat. Nos. 4,720,432, and 4,885,211.

According to U.S. Pat. No. 5,429,884, Japanese Patent Application Laid-Open No. H05-159882, U.S. Pat. Nos. 5,457,565, 5,739,635, and 5,776,622, in order to improve an injection property of an electron from the cathode side, improvements of light emission efficiency have been studied by inserting a metal, an alloy, a metallic compound, or the like, in which a work function is small and electrocondcitivity is high, for example, an oxide of alkali metal such as Li, Na, K, Rb, or Cs, a halide, a nitride, or an oxide of alkali metallic salt or alkali earth metal, between the cathode and an organic matter.

Here, there are the following problems. Since the alkali metal or the alkali earth metal is used as the material having the high electron injection property, chemical stability is low. Oxidation and deliquescence are produced only on exposure to air or moisture, so that a device is likely to deteriorate. In a manufacturing process, a reagent is hard to handle and maintenance of an apparatus is complicated. When an Al—Li alloy or an Ag—Mg alloy in which the chemical stability is improved is used, those problems are solved. However, it is hard to control a composition of an evaporation film.

### SUMMARY OF THE INVENTION

Therefore, an object of the present invention is to provide an electron injection material which has high chemical stability and is easy to control a composition of a film. Thus, an object of the present invention is to provide an organic electroluminescent device having extremely high efficiency and a light output with high luminance and an organic electroluminescent device having extremely high durability.

An organic electroluminescent device according to the present invention includes at least: a pair of electrodes including an anode and a cathode; one or more layers containing an organic compound interposed between the pair of electrodes; and a layer containing metallic boride provided between the cathode and one of the layers containing the organic compound.

An organic electroluminescent device according to the present invention includes the following as preferred aspects. The metallic boride is at least one selected from the group consisting of magnesium diboride, calcium hexaboride, barium hexaboride, lanthanum hexaboride, silicon hexaboride, silicon tetraboride, strontium hexaboride, zirconium diboride, titanium diboride, and vanadium diboride. The layer containing the metallic boride includes a thin film of the metallic boride. The layer containing the metallic boride includes a mixed layer of the metallic boride and an organic material. The layer containing the metallic boride includes an electro injection layer adjacent to the cathode.

According to the organic electroluminescent device of the present invention, the metallic boride is used as the electron injection material. Therefore, the high chemical stability can be obtained, the composition of the film can be easily controlled, and the light output with the high luminance can be taken at extremely high efficiency.

### BRIEF DESCRIPTION OF THE DRAWINGS

FIG. 1 is a sectional view showing an example of an organic electroluminescent device of the present invention.

FIG. 2 is a sectional view showing another example of the organic electroluminescent device of the present invention.

FIG. 3 is a sectional view showing another example of the organic electroluminescent device of the present invention.

FIG. 4 is a sectional view showing another example of the organic electroluminescent device of the present invention.

FIG. 5 is a sectional view showing another example of the organic electroluminescent device of the present invention.

FIG. 6 is a sectional view showing another example of the organic electroluminescent device of the present invention.

### DETAILED DESCRIPTION OF THE PREFERRED EMBODIMENTS

Hereinafter, an organic electroluminescent device of the present invention will be described in detail.

According to organic electroluminescent device of the present invention, it is characterized in that metallic boride is used for a layer between a cathode and a layer containing an organic compound, preferably, an electron injection layer adjacent to the cathode.

Examples of the metallic boride include: magnesium diboride, calcium hexaboride, barium hexaboride, lanthanum hexaboride, silicon hexaboride, silicon tetraboride, strontium hexaboride, zirconium diboride, titanium diboride, and vanadium diboride.

A layer containing the metallic boride can be selected from a single layer of the metallic boride or a mixed layer of the metallic boride and an organic material (preferably, an organic material having electron transportability).

The organic materials for the mixed layer are not particularly limited as long as they are organic materials which may be available as luminous layers and electron transporting layers. For example, fused polycylic hydrocarbon compounds such as napthalene, anthracene, tetracene, pyrene, chrysene, coronene, naphthacene, phenanthrene, and derivatives thereof; fused heterocyclic compounds such as phenanthroline, vasophenanthroline, phenantolidine, acridine, quinoline, quinoxaline, and derivatives thereof; or perylene, phthaloperylene, naphthaloperylene, perynone, phthaloperynone, naphthaloperynone, oxadiazole, fluorene, fluoroscein, diphenylbutadiene, tetraphenylbutadiene, bisbenzoxazoline, bisstyryl, pyrazine, cyclopentadieneoxine, aminoquinoline, imine, diphenylethylene, vinylanthracene, diaminocarbazole, pyran, thiopyran, polymethine, merocyanine, quinacridone, rubrene, and derivatives thereof.

Although the amount of metallic boride with which the mixed layer is doped is not particularly limited, the amount of metallic boride is desirably 0.1 weight % to 99 weight %. When the amount of metallic boride is smaller than 0.1 weight %, a concentration of the dopant is too low, so that a dopant effect is small.

Although a thickness of the single layer is not particularly limited, the thickness is preferably 1 angstrom to 1000 angstroms. When the thickness is smaller than 1 angstrom, sufficient electron injection property is not obtained in some cases. When the thickness exceeds 1000 angstroms, the movement of carrier is likely to disappear.

Although a thickness of the mixed layer is not particularly limited, the thickness is preferably 5 angstroms to 3000 angstroms. When the thickness is smaller than 5 angstroms, the amount of injection metallic molecule present near an electrode boundary is small, so that the injection property is not improved in some cases. When the thickness exceeds 3000 angstroms, the entire organic film becomes thicker, so that a drive voltage is likely to rise.

Any thin film formation method may be used as a method of forming the layer containing the metallic boride. For example, an evaporation method or a sputtering method can be used.

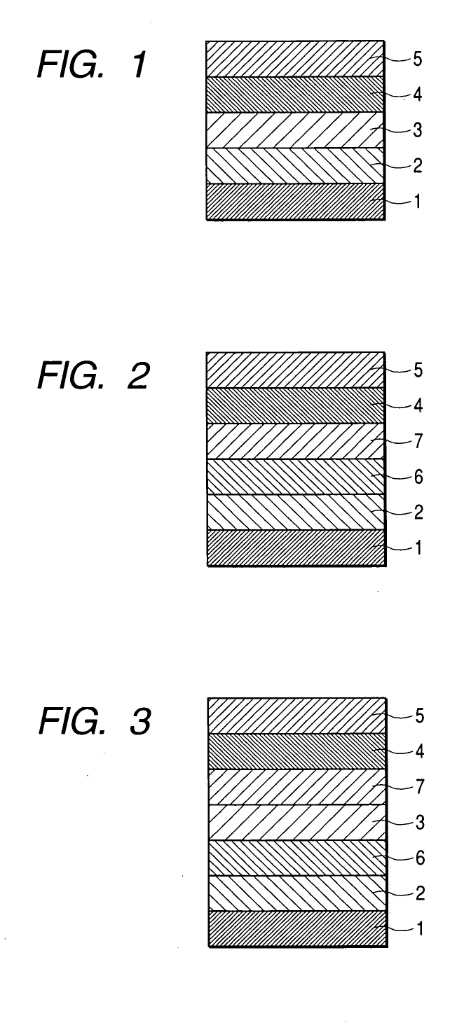

FIGS. 1 to 6 show structural examples of the organic electroluminescent device of the present invention.

First, reference numerals in FIGS. 1 to 6 will be described. Reference numeral 1 denotes a substrate, 2 denotes an anode, 3 denotes a luminescent layer, 4 denotes an electron injection layer, 5 denotes a cathode, 6 denotes a hole transporting layer, 7 denotes an electron transporting layer, 8 denotes a hole injection layer, and 9 denotes a hole/exciton blocking layer.

FIG. 1 is a sectional view showing an example of the organic electroluminescent device of the present invention. In FIG. 1, the anode 2, the luminescent layer 3, the electron injection layer 4, and the cathode 5 are provided in order on the substrate 1. This example is useful in the case where a luminescent material used here has performances such as hole transporting power, electron transporting power, and a luminescent property and in the case where compounds each having any of the performances are mixed with one another.

FIG. 2 is a sectional view showing another example of the organic electroluminescent device of the present invention. In FIG. 2, the anode 2, the hole transporting layer 6, the electron transporting layer 7, the electron injection layer 4, and the cathode 5 are provided in order on the substrate 1. This example is useful in the case where a luminescent material having any one of a hole transporting property and an electron transporting property or both properties is used for each of the layers and combined with merely a hole transporting material or an electron transporting material, which has no luminescent property. In this example, any one of the hole transporting layer 6 and the electron transporting layer 7 corresponds to the luminescent layer 3.

FIG. 3 is a sectional view showing another example of the organic electroluminescent device of the present invention. In FIG. 3, the anode 2, the hole transporting layer 6, the luminescent layer 3, the electron transporting layer 7, the electron injection layer 4, and the cathode 5 are provided in order on the substrate 1. In this example, a carrier transporting function is separated from a luminescent function. This example is used in the case where compounds each having any of properties including the hole transporting property, the electron transporting property, and the luminescent property are suitably combined with one another. Therefore, the degree of freedom of material selection significantly increases and various compounds having different luminescent wavelengths can be used, so that the variety of luminescent hue is possible. It is also possible to effectively confine each carrier or exciton in the central luminescent layer 3 to improve the light emission efficiency.

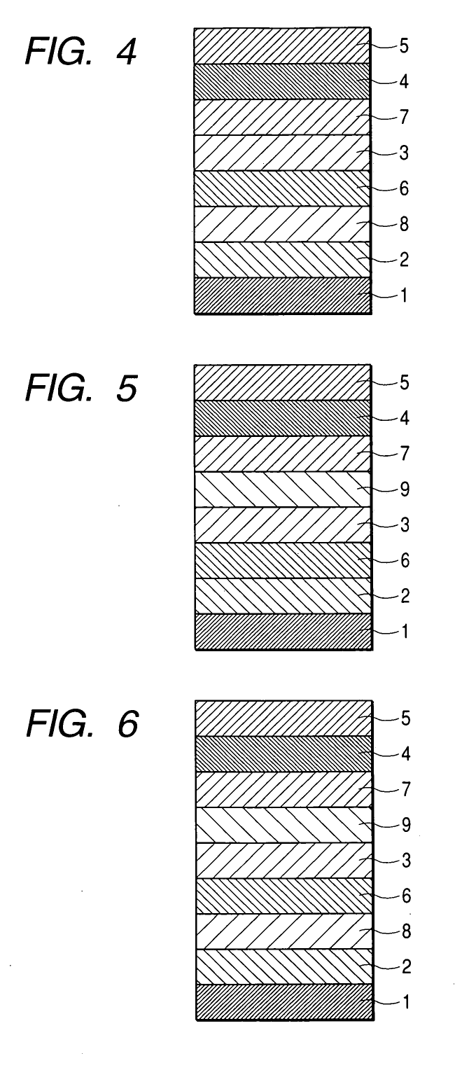

FIG. 4 is a sectional view showing another example of the organic electroluminescent device of the present invention. As shown in FIG. 4, the hole injection layer 8 is inserted between the anode 2 and the hole transporting layer 6 in the structure shown in FIG. 3. Such a structure has an effect to improve adhesion between the anode 2 and the hole transporting layer 6 and a hole injection property, thereby effectively reducing a voltage.

FIG. 5 is a sectional view showing another example of the organic electroluminescent device of the present invention. As shown in FIG. 5, a layer for preventing hole or exciton from penetrating the cathode 5 (hole/exciton blocking layer 9) is inserted between the luminescent layer 3 and the electron transporting layer 7 in the structure shown in FIG. 3. When a compound having a very high ion potential is used for the hole/exciton blocking layer 9, this example is effective to improve the light emission efficiency.

FIG. 6 shows a combination of the structure shown in FIG. 4 and the structure shown in FIG. 5.

FIGS. 1 to 6 show only fundamental device structures. Therefore, the structure of the organic electroluminescent device of the present invention is not limited to those. Various layer structures can be used. For example, an insulating layer is provided in an interface between an electrode and an organic layer, an adhesive layer or an interference layer is provided, or the hole transporting layer is composed of two layers having ion potentials different from each other.

The present invention relates to a luminescent layer or a luminescent region, which has any one of the above-mentioned various structures. Therefore, even when any structure is used, the present invention can be embodied. A hole transporting compound, an electron transporting compound, and the like, which have been known up to now can be used as other constituent elements if necessary.

A material having a small work function is preferably used for the cathode 5. It is possible to use simple metal such as lithium, sodium, potassium, calcium, magnesium, aluminum, indium, silver, lead, tin, or chromium, or an alloy of those. The cathode 5 may be a single layer structure. A multi-layer structure can be also used for the cathode 5. According to the description in U.S. Pat. No. 6,396,209, reducing metal, that is, Al, Zr, Ti, Y, Sc, Si, or the like is used as a material of the cathode. An ion of metal serving as a constituent material of the electron injection layer 4 is reduced to metal in a vacuum to liberate the metal. An organic compound is reduced with the liberated metal, so that an electron injection barrier lowers and a drive voltage reduces. In the case where the metallic boride in the present invention is used for the electron injection layer 4, even when metal having no reduction property is used for the cathode 5, the electron injection property can be improved. Therefore, a material of the cathode 5 can be selected from a wide material range. It is also possible to use metallic oxide such as indium tin oxide (ITO) or indium zinc oxide (IZO).

A material having a maximal work function is preferably used for the anode 2. For example, it is possible to use simple metal such as gold, platinum, nickel, palladium, cobalt, selenium, or vanadium, an alloy of those, or metallic oxide such as tin oxide, zinc oxide, indium tin oxide (ITO), or indium zinc oxide. A conductive polymer such as polyaniline, polypyrrole, polythiophene, or polyphenylene sulfide can be also used. Those electrode materials may be used alone or in combination.

A material of the substrate 1 is not particularly limited. An opaque substrate such as a metallic substrate or a ceramic substrate or a transparent substrate made of glass, quartz, a plastic sheet, or the like is used as the substrate 1. It is also possible to control a luminescent color by using a color filter film, a fluorescent color converting filter film, a dielectric reflection film, or the like for the substrate.

In order to prevent contacts with oxygen, moisture, and the like, a protective layer or a sealing layer can be also provided for the produced device. With respect to the protective layer, there are an inorganic material film such as a diamond thin film, a metallic oxide film, or a metallic nitride film, a polymer film such as a fluororesin film, a polyparaxylene film, a polyethylene film, a silicone resin film, or a polystyrene resin film, a light curable resin film, and the like. The device itself can be also packaged by a suitable sealing resin for covering glass, a gas blocking film, metal, and the like.

Hereinafter, the present invention will be more specifically described with reference to examples. The present invention is not limited to the examples.

### EXAMPLE 1

The organic electroluminescent device shown in FIG. 3 was produced.

An indium tin oxide (ITO) film having a film thickness of 1200 angstroms was formed as the anode 2 on a glass substrate (substrate 1) by a sputtering method. The resultant substrate was used as a transparent conductive support substrate. The substrate was successively subjected to ultrasonic cleaning using acetone and isopropyl alcohol (IPA), and then subjected to boil cleaning using IPA and dried. After that, the substrate was subjected to UV/ozone cleaning.

First, a film of α-NPD (the following formula (1)) was formed at 400 angstroms as the hole transporting layer 6 on the substrate by vacuum evaporation. Second, a film of tris(8-quinolinolato) aluminum (hereinafter referred to as Alq₃ (the following formula (2)) was formed at 200 angstroms as the luminescent layer 3 by vacuum evaporation. Then, a film of bathophenanthroline expressed by the following formula (3) was formed at 400 angstroms as the electron transporting layer 7 by vacuum evaporation.

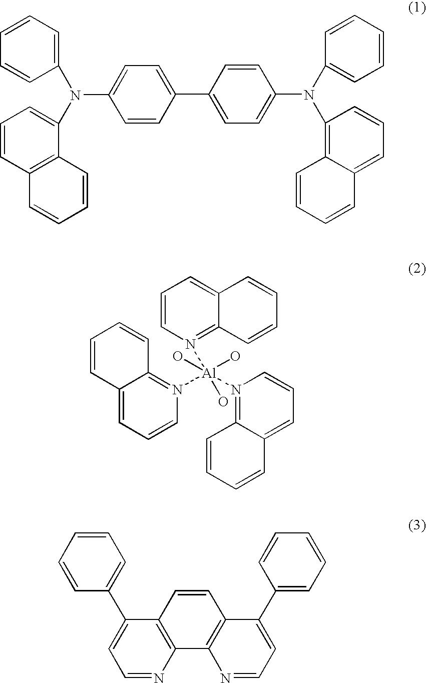

Next, a film of magnesium diboride (MgB₂) was formed at 20 angstroms as the electron injection layer 4 by a vacuum evaporation method. After that, an Al film (cathode 5) was formed at 1500 angstroms by the vacuum evaporation method, thereby producing the device.

The degree of vacuum at evaporation was 2×10⁻⁴ Pa. A film formation rate of the organic layer was 1 angstrom per second and a film formation rate of the cathode 5 was 10 angstroms per second.

The magnesium diboride has no deliquescent property and is resistant to oxidation. Therefore, a stable thin film which is easy to evaporate was obtained.

The thus obtained device was driven at 20 mA/cm² with a state in which the anode 2 is set to a positive electrode and the cathode 5 is set to a negative electrode. As a result, a voltage exhibited 7.0 V. Green light emission of about 2000 cd/m² was obtained. Light emission efficiency was 2.1 lm/W. External quantum efficiency was 1.5%.

### COMPARATIVE EXAMPLE 1

The device was produced as in Example 1 except that a film of lithium fluoride (LiF) was formed at 5 angstroms as the electron injection layer 4.

As in Example 1, the device was driven at 20 mA/cm². As a result, a voltage exhibited 4.5 V. Green light emission of about 600 cd/m² was obtained. Light emission efficiency was 2.1 lm/W. External quantum efficiency was 0.96%.

### COMPARATIVE EXAMPLE 2

The device was produced as in Example 1 except that the cathode 5 was directly laminated on the electron transporting layer 7 without forming the electron injection layer.

As in Example 1, the device was driven at 20 mA/cm². As a result, a voltage exhibited 13.2 V. Green light emission of about 260 cd/m² was obtained. Light emission efficiency was 0.3 lm/W. External quantum efficiency was 0.44%.

Example 1 was compared with Comparative Examples 1 and 2. As a result, the obtained light emission efficiency in Example 1 was the same as that in Comparative Example 1 in which the LiF film was used as the electron injection layer. The external quantum efficiency in Example 1 was very higher than that in Comparative Example 1. As compared with Comparative Example 2 in which no electron injection layer was formed, the device in Example 1 could be driven at lower voltage and the electron injection property was improved.

### EXAMPLE 2

A film of bathophenanthroline expressed by the formula (3) was formed at 200 angstroms as the electron transporting layer 7 by vacuum evaporation. After that, the device was produced as in Example 1 except that bathophenanthroline expressed by the formula (3) and magnesium diboride were formed at 300 angstroms for the electron injection layer 4 by coevaporation such that a molar ratio of those substantially became 1:1.

As in Example 1, the device was driven at 20 mA/cm². As a result, a voltage exhibited 8.8 V. Green light emission of about 760 cd/m² was obtained. Light emission efficiency was 1.3 lm/W. External quantum efficiency was 1.2%.

In Example 2, the metallic boride and the organic compound having the electron transporting property were formed for the electron injection layer 4 by coevaporation. As compared with Comparative Example 2 in which no electron injection layer was formed, the electron injection property was significantly improved.

### EXAMPLE 3

The device was produced as in Example 2 except that Ag was used for the cathode 5.

As in Example 1, the device was driven at 20 mA/cm². As a result, a voltage exhibited 7.0 V. Green light emission of about 580 cd/m² was obtained. Light emission efficiency was 1.3 lm/W. External quantum efficiency was 1.0%. Thus, the same characteristics as those in a device using an Al electrode as the cathode were obtained.

### COMPARATIVE EXAMPLE 3

The device was produced as in Comparative Example 2 except that Ag was used for the cathode 5.

As in Example 1, the device was driven at 20 mA/cm². As a result, a voltage exhibited 14.0 V. Green light emission of about 200 cd/m² was obtained. Light emission efficiency was 0.22 lm/W. External quantum efficiency was 0.32%.

Even when an electrode having no reduction property was used as the cathode 5, the electron injection property was improved by using the electron injection material of the present invention.

### EXAMPLE 4

The device was produced as in Example 2 except that bathophenanthroline expressed by the formula (3) and calcium hexaboride were formed at 300 angstroms for the electron injection layer 4 by coevaporation such that a molar ratio of those substantially becomes 1:1.

When the calcium hexaboride was used, a stable coevaporation thin film which is easy to evaporate was obtained.

As in Example 1, the device was driven at 20 mA/cm². As a result, a voltage exhibited 9.4 V. Green light emission of about 840 cd/m² was obtained. Light emission efficiency was 1.3 lm/W. External quantum efficiency was 1.4%.

### COMPARATIVE EXAMPLE 4

The device was produced as in Example 4 except that the calcium hexaboride was used for the electron injection layer 4.

As in Example 1, the device was driven at 20 mA/cm². As a result, a voltage exhibited 13.4 V. Green light emission of about 270 cd/m² was obtained. Light emission efficiency was 0.3 lm/W. External quantum efficiency was 0.42%.

Example 4 was compared with Comparative Example 4. As a result, the light emission characteristic was significantly improved because the calcium hexaboride was added to form the electron injection layer 4.

The organic electroluminescent device of the present invention as described in the embodiments or the examples can be applied to, for example, a display of an image display portion provided in a digital camera, a display of a personal computer, and a television.

The organic electroluminescent device of the present invention can be also used for an image display portion of a full color display. In this case, organic electroluminescent devices which emit respective light beams of red, blue, and green can be applied to the full color display by arranging the organic electroluminescent devices for each pixel.

A switching device such as a thin film transistor (TFT) is provided for the organic electroluminescent device of the present invention, whereby an active matrix display can be provided.

This application claims priority from Japanese Patent Application No. 2003-361525 filed Oct. 22, 2003, which is hereby incorporated by reference herein.

1. An organic electroluminescent device comprising: a pair of electrodes comprising an anode and a cathode; one or more layers containing an organic compound interposed between the pair of electrodes; and a layer containing metallic boride provided between the cathode and one of the layers containing the organic compound.

2. The organic electroluminescent device according to claim 1, wherein the metallic boride is at least one selected from the group consisting of magnesium diboride, calcium hexaboride, barium hexaboride, lanthanum hexaboride, silicon hexaboride, silicon tetraboride, strontium hexaboride, zirconium diboride, titanium diboride, and vanadium diboride.

3. The organic electroluminescent device according to claim 1, wherein the layer containing the metallic boride comprises a thin film of the metallic boride.

4. The organic electroluminescent device according to claim 1, wherein the layer containing the metallic boride comprises a mixed layer of the metallic boride and an organic material.

5. The organic electroluminescent device according to claim 1, wherein the layer containing the metallic boride comprises an electron injection layer adjacent to the cathode.

6. A display comprising the organic electroluminescent device according to claim 1.

7. The display according to claim 6, further comprising a switching device for driving the organic electroluminescent device to cause active matrix drive.
